(19) United States
(12) Patent Application Publication
(10) Pub. No.: US 2011/0241843 A1
(43) Pub. Date: Oct. 6, 2011

(54) BATTERY-LESS OPERATED BI-STABLE DISPLAY BY WIRELESS POWER TRANSMISSION

(75) Inventors: Sebastien Marsanne, Singapore (SG); Boon Nam Poh, Singapore (SG); Samuel Devanandan, Singapore (SG); San Kaung, Singapore (SG)

(73) Assignee: STMICROELECTRONICS ASIA PACIFIC PTE, LTD., Singapore (SG)

(21) Appl. No.: 12/749,703

(22) Filed: Mar. 30, 2010

(51) Int. Cl. H04Q 5/22; G09G 5/00

(52) U.S. Cl. 340/10.3; 345/204

(57) ABSTRACT

Updating content of e-paper ESL device(s) otherwise in a powered-down state is disclosed. One or more e-paper ESL devices need only be turned on when it is desired or needed to change and update content displayed. Transmission of a wireless energy burst having a magnetic resonating power coupling characteristic powers up the e-paper ESL device from a powered-down to powered-up state. The content of the e-paper ESL device can then be changed in accordance with data and instructions transmitted with the wireless energy burst.

### BACKGROUND

E-Paper devices have displays that are attractive for use in a variety of settings and for a number of purposes, including as traffic signs, billboards, time tables, general signage, and in groceries or retail stores as Electronic Shelf Labels (ESLs). IR guns and other contact-less means are used to update pricing information displayed on the ESL. In the example of a grocery store or retailer, even low power ESL devices with batteries must have their batteries replaced periodically, such as every five years. Replacement of these batteries, which may be button batteries, for a large number of ESL devices, is time consuming and not good for the environment.

Shops and retailers may use an Electronic Shelf Label (ESL) to display price and other information about an item for sale. ESL technology provides the advantage of being able to easily update the information being displayed, such as pricing. Power is needed to keep the picture of the ESL displayed and in today's ESL market, many shops use battery-operated liquid crystal display (LCD) displays that run on replaceable batteries, such as the button battery. A discrete battery may be used to power each ESL. It is important to minimize power consumption in order to maximize the battery lifespan, and it is known that standby leakage current while the ESL in is standby mode depletes battery life significantly. Replacing the battery when needed is a labor intensive operation for a store of any size with many ESLs, and discarding depleted batteries comes with concern for the environment.

### BRIEF DESCRIPTION OF THE DRAWINGS

The accompanying drawings provide visual representations which will be used to more fully describe various representative embodiments and can be used by those skilled in the art to better understand the representative embodiments disclosed and their inherent advantages. In these drawings, like reference numerals identify corresponding elements.

FIG. 1 is a block diagram of an ESL system, in accordance with various representative embodiments.

FIG. 2 is a block diagram illustrating functional blocks of an ESL system of FIG. 1, in accordance with various representative embodiments.

FIG. 3 is an illustration of the magnetic resonator of the wireless power transmitter of FIG. 2, in accordance with various representative embodiments.

FIG. 4 is a block diagram illustrating the functional blocks of an e-paper ESL device disclosed in the system of FIG. 1, in accordance with various embodiments.

FIG. 5 is a further block diagram illustrating functional blocks of an e-paper ESL device, in accordance with various embodiments.

FIG. 6 is a functional block diagram of a switched mode power supply or relay, in accordance with various embodiments.

FIG. 7 illustrates frame information, in accordance with various embodiments.

FIGS. 8 and 9 are flowcharts that illustrate device and system methodology, respectively, in accordance with various embodiments.

### DETAILED DESCRIPTION

As shown in the drawings for purposes of illustration, an e-Paper ESL device, system and methodology provide for updating content of e-paper ESL device(s). The e-paper ESL device is only turned on when it is desired or needed to change and update content. Transmission of a wireless energy burst having a magnetic resonating power coupling characteristic and comprised of instructions and data powers up the e-paper ESL device from a powered-down to powered-up state so that its content can be changed in accordance with data and instructions transmitted with the wireless energy burst.

In accordance with certain embodiments, an e-Paper ESL device is disclosed, the device having a processor and control element; a power antenna receiver coupled to the processor and control element; a memory element coupled to the processor and control element; a display element coupled to the processor and control element and comprised of electronic paper with a bi-stable electronic ink, wherein the display continues to display content stored in the memory element of the e-paper electronic shelf label device when no power is supplied to the e-paper electronic shelf label device in a powered-down state. In response to the power antenna receiver receiving a wireless energy burst with a wireless magnetic resonating power coupling characteristic when the e-paper electronic shelf label device is in a powered-down state, the processor and control element controls the switched mode power relay to power on the e-paper electronic shelf label device from the powered-down state to a powered-up state. As used herein, electronic paper, e-paper, or electronic ink display are interchangeable terms used to reference display technology that mimics the appearance of ordinary ink on paper by reflecting light like ordinary paper. It is able to hold text and images indefinitely without drawing electricity, unlike a conventional flat panel display that illuminates pixels or a reflective LCD display that requires regular screen content refresh.

The wireless energy burst further comprises instructions and data for updating content displayed by the display element. The data transmission can be embedded in the wireless power transmission or use other contact-less means such as electromagnetic or optical transmission. Upon the wireless energy burst powering up the e-paper electronic shelf label device to the powered-up state, the processor and control element controls the display element in accordance with the instructions to display content determined by the data transmitted during the wireless energy burst.

The one or more e-paper electronic shelf label devices may be battery-less, rechargeable, with a capacitive energy store element, or some combination thereof.

In accordance with certain embodiments, a system for updating content of a number of e-paper ESL device is disclosed, the system has an update device operable to transmit a wireless energy burst having a wireless magnetic resonating power coupling characteristic and comprised of instructions and data in response to activation of a power activation element of the update device; and a number of e-paper electronic shelf label devices. Each e-paper electronic shelf label device has a powered-down state in which the e-paper electronic shelf label device continues to display content when no power is supplied to the e-paper electronic shelf label device in the powered-down state. In response to activation of the power activation element of the update device, the update device transmits the wireless energy burst, along with instructions and data is received by one or more e-paper electronic shelf label devices of the plurality of e-paper electronic shelf label devices, the one or more e-paper electronic shelf label devices power-up to a powered-up state, and the powered-up one or more e-paper electronic shelf label devices update and display content in accordance with the instructions and data of the received wireless energy burst.

In accordance with certain embodiments, a method for updating content of an e-paper ESL device is disclosed. The e-paper electronic shelf label device receives a wireless energy burst comprising instructions and data when in a powered-down state, with the wireless energy burst having a wireless magnetic resonating power coupling characteristic and having instructions and data for updating content displayed by the e-paper ESL. The e-paper ESL device is powered up from the powered-down state to a powered-up state. In accordance with certain embodiments, this is performed by a switched mode power relay of the e-paper electronic shelf label device under control of a processor and control element of the e-paper electronic shelf label device. The content displayed by the e-paper electronic shelf label device is updated in accordance with the instructions and data of the received wireless energy burst.

In accordance with certain embodiments, a method for updating content of an e-paper ESL device in a system is disclosed. In response to activation of a power activation element of an update device, a wireless energy burst having a wireless magnetic resonating power coupling characteristic and comprised of instructions and data is transmitted. A number of e-paper electronic shelf label devices with range receive the wireless energy burst with instructions and data while in a powered-down state. The e-paper electronic shelf label devices power up from the powered-down state to a powered-up state. The content displayed by the e-paper electronic shelf label devices can then be updated in accordance with the instructions and data of the received wireless energy burst.

Using the drawings, the various embodiments of the present invention, including preferred embodiment(s) will now be explained. In the following detailed description and in the several figures of the drawings, like elements are identified with like reference numerals.

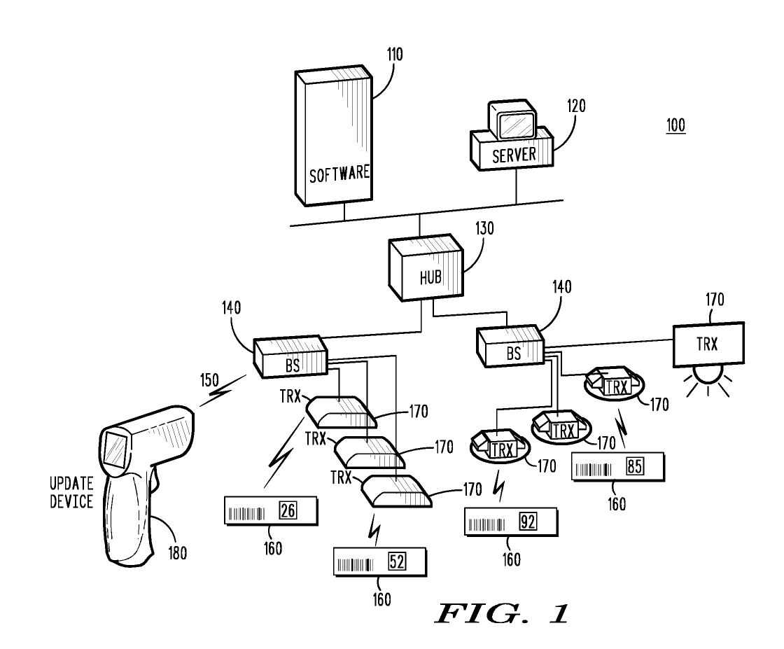

Reference is now made to FIG. 1 of the drawings, in which a ESL system 100 using wireless communications is shown. System 100 has a server computer 120 that can run software 110 and a hardware platform, represented by hub 130, base stations 140, update device 180, transceivers 170, and e-Paper ESLs 160. The wireless communications may include infrared (IR) communications or other desired wireless communications.

Base stations 140 may be wall-mounted, for example, and are coupled to hub 130 as well as a number of transceivers 170 as shown, and handle modulation and frequency generation for the carrier of the system. Transceivers 170, which may be mounted to the ceiling of a store or retail location, receive electrical signals from a base station 140 and convert them to IR signals, which can then be transmitted to a number of e-Paper ESLs 160. A number of transceivers are connected to base station 140, which is connected to server 120 via a hub 130. As will be described, transceivers can transmit data and/or power, as in the case of a fully automated retail environment, like a supermarket.

Antennas located on the shop/store ceiling in transceivers 170 can receive an energy burst with data and instructions for updating the content displayed by e-paper ESLs 160. The energy burst with data is routed to individual ESLs 160. Power antenna receivers in ESL devices receive energy burst with data directly. Content displayed by the ESL devices is updated to reflect the content data beamed with the energy burst.

Distribution of collection power antenna transceivers throughout a space thus aid in control of multiple ESL devices throughout the space. The wireless energy burst transmits in a mid-range distance ranging from approximately centimeters to several meters. A distance of one meter between an IR/wireless power gun update device and one or more power antenna receivers to receive the wireless energy burst works well in most retail and grocery settings. A burst of power can thus operate to update all price tags within range. The wireless energy burst may be of a few seconds duration when the wireless update device is activated.

An advantage of battery-less e-paper ESLs include no leakage current in a stand-by mode of display, since display is in a powered-down state except when the display image content is being updated/changed. When the display content does not change, the ESL device is inert; there is no leakage. There is no need to change the battery of many ESL device, which can be quite labor intensive for an operation of any size. There is no battery maintenance. Moreover, the useful life of a battery-less ESL display is very long.

Since no batteries are required, the ESL display device can be a fully closed device that is water proof, tamper proof. It need not have an open cavity in which to insert a battery. Benefits that can be realized include magnetic coupled power transmission that transfers energy wirelessly for a short duration of time, reducing concern about body radiation exposure, and magnetic coupling that allows only a frequency matched antenna with transmitter to respond to a particular frequency, similar in effect to Walky-Talkies Channel Selection works.

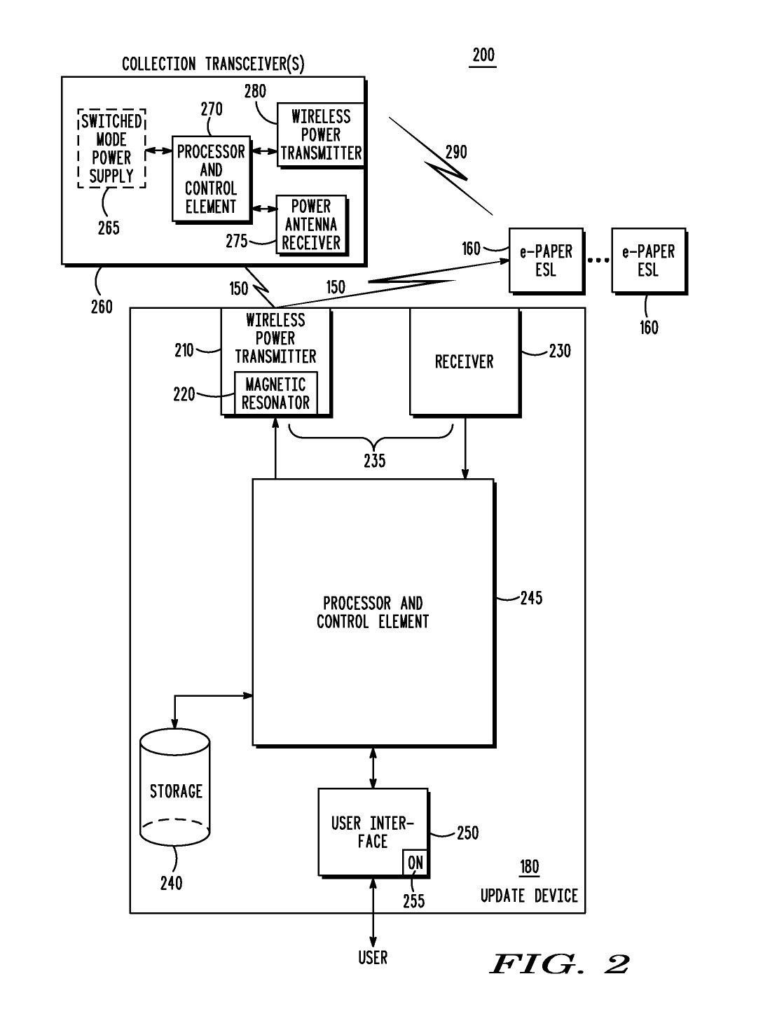

The functional block diagram of a system comprised of an update device 180, a collection transceiver(s) 260, and one or more e-Paper ESLs 160 is illustrated in FIG. 2. As will be shown, the update device has a processor and control element, a wireless power transmitter coupled to and controlled by the processor and control element and operable to generate the wireless energy burst containing instructions and data, and a user interface coupled to and controlled by the processor and control element and having the power activation element. The wireless energy burst beamed by the wireless power transmitter is a magnetic resonating wireless transmission and the transmitter has a magnetic resonator having a resonating frequency. The magnetic resonator may have an inductor coil element and a capacitance plate element, where the shape of the inductor coil element determines the resonating frequency of the wireless power transmitter. In response to a user activating the power activation element of the user interface, the processor and control element of the update device controls the wireless power transmitter to transmit the wireless energy burst having the wireless magnetic resonating power coupling characteristic. The update device may be a wireless update device, such as a portable IR or RF gun with an integrated wireless transmitter as shown.

The collection power antenna receivers 260 may be located at one or more corresponding collection devices located at collection locations within the system; this is illustrated by transceivers, hub and base stations 170, 130 and 140, respectively. The wireless energy burst is received by the one or more collection power antenna transceivers which then transmit the received energy burst and data to the one or more e-paper electronic shelf label devices 160. The collection locations may be located at a ceiling in an area above the one or more e-paper electronic shelf label devices, or embedded in a portable “IR gun”. The wireless energy burst received by the one or more collection power antenna transceivers from the update device powers up the one or more collection devices containing the one or more collection power antenna transceivers and the one or more collection power antenna transceivers transmit the received energy burst and data to the power antenna receivers of the one or more e-paper electronic shelf label devices.

The update device can be used to directly update information displayed by the e-Paper ESLs 160 by wireless energy burst 150 without use of one or more collection transceivers 260, or via one or more collection transceiver(s) 260 that collect the wireless energy burst and then transmit another wireless energy burst 290 that is received by power antenna receivers of the e-Paper ESLs, as will be described. It is noted that when the energy burst is first received by collection transceivers 260 which then in turn transmit a wireless energy burst 290 via wireless power transmitter 280 to turn on and update the e-Paper ESLs 160, the collection transceiver(s) may be considered as providing the functionality of an update device. If transceivers 170, base stations 140 and/or hub devices 130 serve as collection transceiver update devices, then these update device would not be portable.

The functional relationship between the user interface, processor and control element, wireless power transmitter and receiver elements of update device 180 are illustrated. The update device 180 may be a portable, hand-operated device, such as an IR or RF gun, capable of beaming a short power burst of energy containing data and instructions necessary to update e-Paper ESL devices 160. The update device 180 transmits data and power, and in the case of a retail environment, may be the source of manual updates. A small wireless power transmitter 210 containing a magnetic resonator element 220 is integrated in the gun.

The update device 180 has a user interface 250 through which a user may remotely control operation of the e-Paper ESLs; a processor and control element 245 that processes instructions received from the user via the user interface 250 and generates control signals in accordance with those instructions; a receiver 230 of the communications unit 235 that receives signals from the e-Paper ESLs 160 and/or collection transceivers 260 and provides those received signals to the processor and control element 245; and a wireless power transmitter 210 of communications unit 235 that transmits the control signals generated by the processor and control element 245 under control of the processor and control element.

The update device 180 further has a user interface 250 by which the user may send and receive information. The user interface 250 features a display, for example a liquid crystal display (LCD), on which data and information via receiver 230 or input provided by a user of update device 180 may be displayed.

The user interface 250 may feature a plurality of keys or buttons by which a user can enter instructions or data to be sent to the e-Paper ESL 160 or instructions to be received by the processor and control element 245, as will be described. In particular, an ON button 255 of the user interface 250 can be used to transmit a wireless energy burst having a wireless magnetic resonating power coupling characteristic, described below. The energy burst is a temporary energy burst of power and duration sufficient to be received by the power antenna receiver within mid-range proximity, limiting exposure to persons in proximity of the burst. For example, the wireless energy burst may range from approximately 200 to 400 mW and the energy pulse of duration approximate the time it takes to press a button.

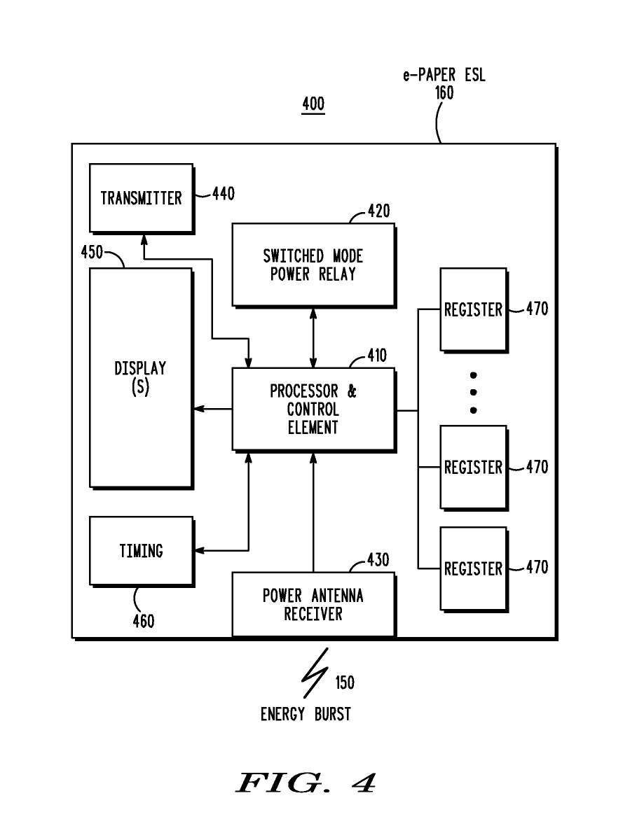

The communications unit 235 of the update device 180 includes a wireless power transmitter 210 and a receiver 230 for both sending and receiving data signals from the e-Paper ESLs 160. The e-Paper ESLs 160 are equipped with a corresponding power antenna receiver 430, as shown in FIG. 4, for receiving signals a wireless power burst directly from update device 180 or via collection transceivers 260. The signaling 150 and 290 between the block diagram devices is wireless magnetic resonating transmission.

In response to a user activating the power ON activation element 255 of the user interface 250, the processor and control element 245 controls the wireless power transmitter 210 and its magnetic resonator 220 to transmit the wireless energy burst having the wireless magnetic resonating power coupling characteristic. Energy collection of the power generated by magnetic resonator 220 takes place in a power antenna receiver in a receiving device, such as an e-paper ESL or collection transceiver.

E-Paper ESLs, contrary to battery-powered ESLs, do not have batteries. Once the information to be displayed is programmed, the electronic ink of an e-Paper ESL is bi-state and the display picture is preserved even if power is removed from the device for a long period of time. Moreover, little power is needed to change the display image content of the e-Paper ESL. Thus, in normal operation, the e-Paper ESL is “off” in that it is not running off power, battery or otherwise. The vast majority of the time, the e-Paper ESL remains in this state, offering the advantage of not needing a battery and thus not having to undergo the time-consuming and expensive process of having to replace batteries of many ESLs as they go bad.

To change the content of the image displayed, then, power must be supplied to the e-Paper ESL device.

In order to power the e-Paper ESLs 160 back on so that their display content information to be displayed can be changed as desired, a user of the update device 180 may activate a power ON feature of the update device, such as by pressing ON button 255 of user interface 250, to cause the wireless power transmitter 210 to beam a wireless energy burst having the wireless magnetic resonating power coupling characteristic that, when received by a power antenna receiver of e-Paper ESL 160 while e-Paper ESL 160 is in a powered-down state, will cause e-Paper ESL 160 to power on from a powered-down state. The energy burst transmitted by wireless power transmitter 210 causes a processor and control element of e-Paper ESL 160 to control a switched mode power relay, such as a bi-stable power switch, of e-Paper ESL 160 to power up the device.

Once the e-Paper ESL 160 is powered back up, it is operable to resume normal operation in the operational mode after a predetermined period of time. And, after a subsequent period of inactivity of the e-Paper ESL, the switched mode power relay powers down the e-Paper ESL causing it to go to the powered-down state.

The wireless energy burst transmitted has a wireless magnetic resonating power coupling characteristic that is beamed within a mid-range distance of the update device. In accordance with wireless magnetic resonating technology, such as that available from WiTricity Corporation of Watertown, Mass., USA, the wireless energy burst is beamed within a mid-range distance that may range from approximately centimeters to several meters.

Wireless power transmitter 210 in certain embodiments has a magnetic resonator element 220 with a resonating frequency; the resonating frequency of the power transmitter 210 may be matched by the frequency of the receiver of the e-paper ESL, such as power antenna receiver element 430 of FIG. 4. A benefit of the resonating frequency is that it allows e-Paper ESLs 160 to be selectively powered on. Thus an update device 180 may selectively power up certain e-Paper if the resonating frequency of the devices match.

The collection transceiver(s) 260 may be comprised of one or more base stations 140, to which a number of transceivers are connected, as shown in FIG. 1, or to a hub device 130, also shown in FIG. 1, to which one or more base stations 140 are connected to a system server 120 via the hub device. Whether the wireless energy burst 150 is received by collection transceiver(s) 260 and/or a plurality of e-Paper ESLs 160, the receiving devices must have power antenna receivers capable of receiving the wireless energy burst and, at least in the case of the e-Paper ESLs 160, a switched mode power relay capable of being turned on in response to receipt of the energy burst. As illustrated by the dashed box of collection transceiver 260, switched mode power supply 265 is optional, in the event that collection transceiver(s) 260 is always on when the wireless power burst 150 is received and thus does not need to be turned on before processor and control element 270 causes wireless power transmitter 280 to transmit wireless power burst 290 to e-Paper ESLs 160 as shown.

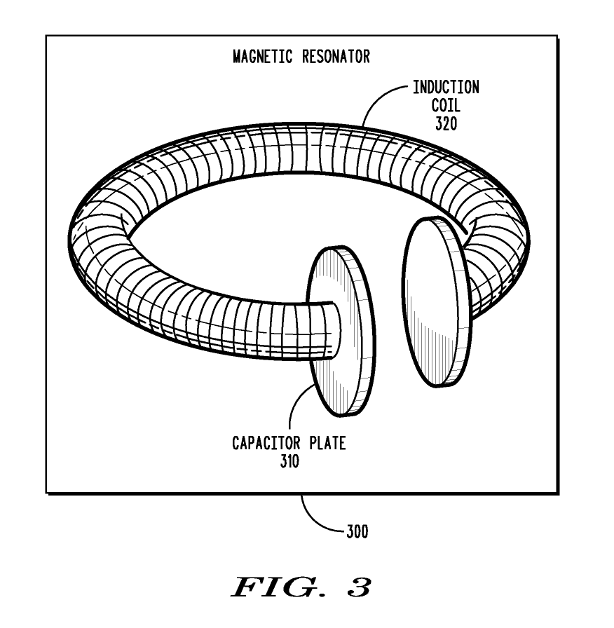

Referring now to FIG. 3, magnetic resonator 220 of wireless power transmitter is further represented by magnetic resonator element 300. The magnetic resonator 300 has a capacitance plate element 310 and an inductor coil element 320 and is characterized by a resonating frequency determined by the shape of the inductor coil element 320, which may vary. It is noted that the capacitance plate may also be comprised of capacitor elements or capacitance distributed along the inductance of inductor coil element 320. The magnetic resonator element 300 as the wireless magnetic resonating power coupling characteristic beamed by the wireless power transmitter 210 of update device 180. The wireless energy burst may be beamed within a mid-range distance of the update device 180; the mid-range distance may range from approximately a centimeter to several meters. The e-Paper ESLs 160 will be within this range to receive the wireless energy burst; the power antenna receiver 430 will receive this wireless burst of energy, as shown in FIG. 4.

Referring now to FIG. 4, a block diagram of the functional elements of an e-Paper ESL 160 in communication with update device 180 of system 400 is shown. In accordance with certain embodiments, each e-paper electronic shelf label device has a processor and control element, a power antenna receiver coupled to and controlled by the processor and control element, a display element coupled to and controlled by the processor and control element, a switched mode power relay; and a memory element coupled to and controlled by the processor and control element in which content displayed by the display of the e-paper electronic shelf label device is stored. In response to the power antenna receiver of an e-paper ESL receiving the wireless energy burst when the e-paper electronic shelf label device is in a powered-down state, the processor and control element controls the switched mode power relay to power on the e-paper electronic shelf label device from the powered-down state to the powered-up state.

While the e-paper ESL device may be battery-less, it may also alternatively or in combination be rechargeable or have a capacitive energy storage element.

e-Paper ESLs 160 comprises a switched mode power relay 420 and a power antenna receiver 430 in operable communication and under the control of processor and control element 410. Processor and control element 410, which may be an application specific integrated circuit (ASIC), a microcontroller unit, or a microprocessor, is in operable communication with and control display element 450, which may be one or multiple displays 450, memory storage elements shown as registers 470, and optional item timing element 460.

Processor and control element 410 receives and acts on commands and information received. e-Paper ESLs 160 may have a transmitter 440 in addition to receiver 430 to enable two-way communications. Processor and control element 140 controls one or more displays 450 to display a variety of information stored in registers 470, and also controls updating of the registers 470 based upon information received by power antenna receiver 430.

The information displayed by the one or more displays 450 of e-Paper ESL 160 may comprise a number of fields, such as price per unit, price per item, a special offer, a discount field, etc. An indicator field may indicate a discount and may be in color to attract consumer attention, for example. An image field may be used for displaying an image. A name field may display the name of a product or service. A price field may display the price of a product or service. The display of an e-paper ESL has electronic paper with a bi-stable electronic ink.

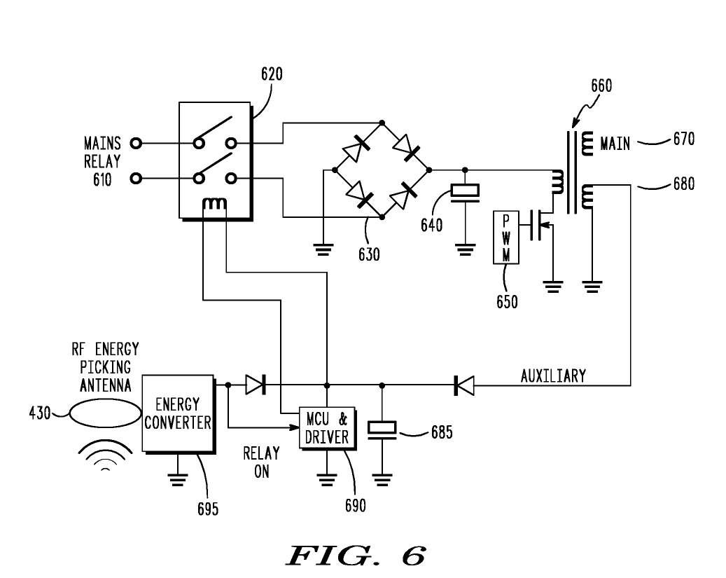

Power antenna receiver 430 operates to receive wireless power bursts and instructions and content data sent to e-Paper ESL 160, such as commands and information updates sent from collection transceivers 260 or from handheld update device 180. In response to the power antenna receiver 430 receiving a wireless energy burst sent by wireless power transmitter 210 or by wireless power transmitter 280 when e-Paper ESL 160 is in a powered-down state, the processor and control element 410 controls the switched mode power relay 420 to power on the e-Paper ESLs 160 from the powered-down state to a powered state. The switched mode power relay 420 is further illustrated in FIG. 6 as a bi-stable power switch, in certain exemplary embodiments.

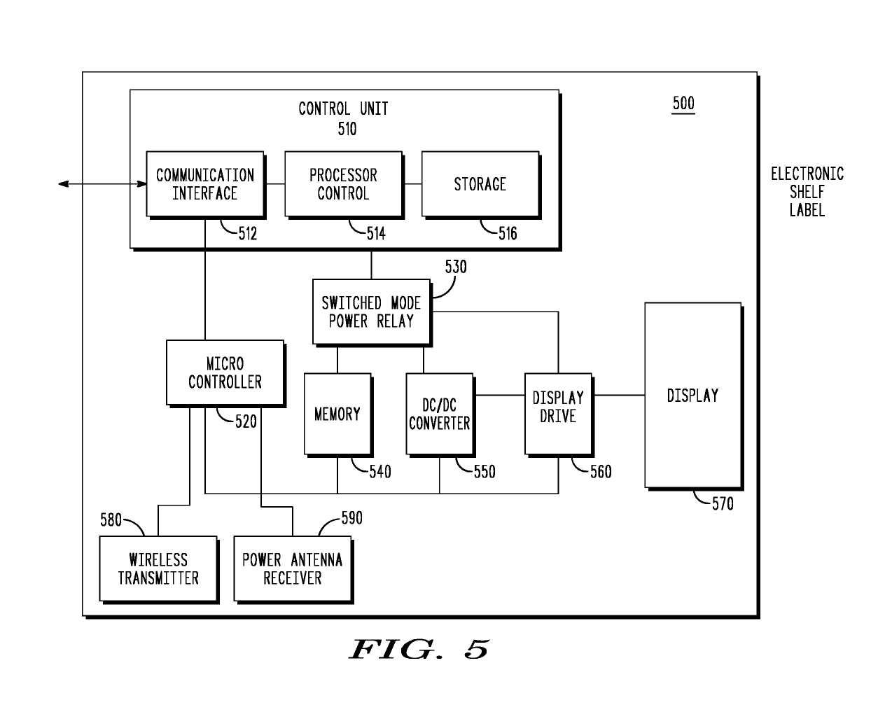

An exemplary embodiment of an e-Paper ESL 500 is illustrated in FIG. 5. e-Paper ESL 500 has a control unit 510 comprised of a communications interface 512, a processing element 514, and storage element 516; a microcontroller element 520; a switched mode power source 530 as explained above in connection with switched mode power relay 420; a memory element 540; a converter 550; a display driver 560; and display(s) 570. Communications interface 512 allows control unit 510 to communicate wireless with server 120 of the ESL system. Thus, communications interface 512 received updated information from the server, including positioning information about how/where data, such as pricing information, is to be displayed by display(s) 570. Display 570 may be a screen with bi-stable electronic ink. Processing element 514 processes the received information and related this to image content displayed by display(s) 570, which may also be stored in storage element 516.

Microprocessor 520 controls the wireless transmitter 580 and power antenna receiver 590, corresponding to power antenna receiver 430 of FIG. 4. Microcontroller 520 also is coupled to memory element 540, converter 550 and display driver 560 as shown. Display driver 560 may operate to convert power provided by power source 530 to a high enough level to update the display 570. Switched mode power source 530 powers the elements of e-Paper ESL 500.

Referring now to FIG. 6, a switched mode power supply or relay 600 in accordance with various embodiments is illustrated. Antenna receiver 430 is an RF energy picking antenna that detects the energy burst transmitted by wireless power transmitter 210 or wireless power transmitter 280. As previously mentioned, the frequency of power antenna receiver 430 may be matched to the resonating frequency produced by magnetic resonator 220 of wireless power transmitter 210.

Switched mode power relay 600 may have the following elements configured and arranged as shown in FIG. 6: mains relay 610, switch 620, diode bridge 630, capacitor 640, pulse width modulator (PWM) 650, a transformer with center tap 660 having a main winding 670 and an auxiliary winding 680, capacitor 685, microcontroller unit (MCU) and driver element 690, and energy converter element 695.

In an embodiment in which a wireless energy burst is received by the one or more collection power antenna transceivers from the update device to power up the one or more collection devices containing the one or more collection power antenna transceivers and that the one or more collection power antenna transceivers transmit the received energy burst and data to the power antenna receivers of the one or more e-paper electronic shelf label devices, mains relay 610, switch 620, diode bridge 630, capacitor 640, pulse width modulator (PWM) 650, a transformer with center tap 660 having a main winding 670 and an auxiliary winding 680 are in cooperative arrangement with power antenna receiver 430, capacitor 685, microcontroller unit (MCU) and driver element 690, and energy converter element 695 as shown.

With regards to certain e-paper ESL embodiments, however, there is no Mains relay, and power relay comprise only power antenna receiver 430, capacitor 685, microcontroller unit (MCU) and driver element 690, and energy converter element 695. In this case, there would be a connection from the MCU & Driver element 690 to the e-paper ESL display, such as display element 450. Capacitor element 685 functions as the local energy storage. The e-paper ESL is so low power to operate that charging the capacitor 685 is enough to change the display picture content as needed.

Switched mode power relay 600 illustrates one implementation to allow the device to “wakeup” from a powered-down state to a standby mode using a relay approach. When the power supply is OFF, there is no current drawn by the main side 670. The mains relay 610 turns ON only when there is enough energy picked by up RF energy picking antenna 430 and supplied to MCU and driver element 690. When enough energy is received, the MCU and driver circuit element 690 turns on the mains relay 620 and the supply to the MCU and driver element 690 is provided from the auxiliary winding 680 of the main power supply transformer. Even with the energy converter 695 OFF, the MCU and driver element 690 will continue to be kept operating by this auxiliary supply. Power consumption as low as approximately 120 mW has been achieved. Reference is made to printed circuit board relay PCT Power Relay G6DS by Omron as a miniature relay with single pole switching capability as an exemplary switching power supply device.

Elements 610, 620, 630, 640, 650, 660, 670, and 680 may optionally be replaced by a large capacitor.

It is noted that the microcontroller unit MCU may be represented by discrete components, such as discrete analog or digital components, that provide the same functionality.

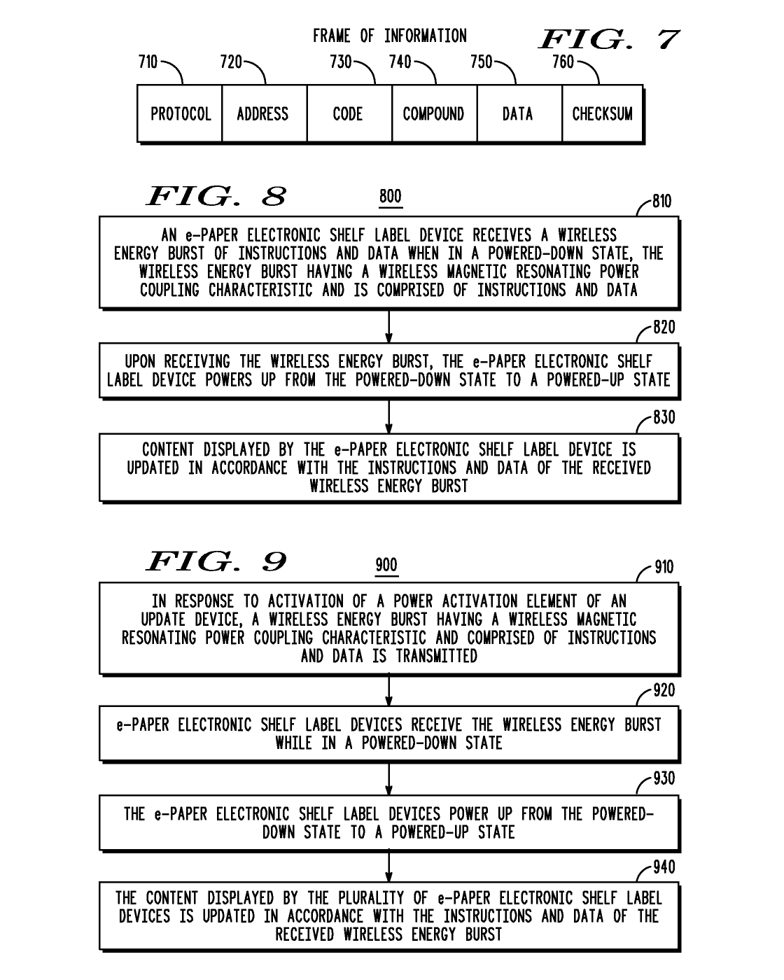

FIG. 7 illustrates a frame 700 of information that may be used in communications in the ESL system of FIG. 1. Protocol field 710 details the protocol to be used for communication. Address field 720 contains address information of the e-Paper ESLs to be communicated with, i.e. to be “awakened” by the short wireless burst of energy. Code field 430 may contain an authorization code for certain commands, such as to update information. Command code 740 contains the command to be sent to the e-Paper ESLs. Data field 750 contains data, such as updates, image updates, etc. to be displayed by the label. Checksum field 760 may be used to ensure accuracy.

Referring now to FIGS. 8 and 9, methodologies for updating e-paper ESLs are illustrated. In the flowchart 800 of FIG. 8, a methodology illustrative of a flow from an e-paper ESL device perspective is shown. At Block 810 an e-paper electronic shelf label device receives a wireless energy burst of instructions and data when in a powered-down state. The wireless energy burst has a wireless magnetic resonating power coupling characteristic and is comprised of instructions and data. As previously described, a power antenna receiver of the e-paper electronic shelf label device receives the wireless energy burst. At Block 820, upon receiving the wireless energy burst, the e-paper electronic shelf label device powers up from the powered-down state to a powered-up state. This is performed by a switched mode power relay of the e-paper electronic shelf label device under control of a processor and control element of the e-paper electronic shelf label device. At Block 830, content displayed by the e-paper electronic shelf label device is updated in accordance with the instructions and data contained within the received wireless energy burst. As discussed, the data transmission can be embedded in the power burst transmission or using another wireless method, such as IR.

Referring now to flowchart 900 of FIG. 9, a methodology illustrative of a flow of a system having an update device and a number of e-paper ESL devices is shown. In response to activation of a power activation element of an update device, a wireless energy burst having a wireless magnetic resonating power coupling characteristic and comprised of instructions and data is transmitted at Block 910. Transmission of the wireless energy burst is performed by a wireless power transmitter of an update device. As noted, the wireless power transmitter may have a magnetic resonator with a resonating frequency and the power antenna receiver of the e-paper electronic shelf label may have a resonating frequency proximate that of the magnetic resonator of the wireless power transmitter.

At Block 920, the e-paper electronic shelf label devices receive the wireless energy burst while in a powered-down state. As previously noted, the e-paper electronic shelf label devices continue to display content when no power is supplied to them in their powered-down state. Receipt of the wireless energy burst for each e-paper electronic shelf label device of the plurality of e-paper electronic shelf label devices is accomplished by a power antenna receiver of the e-paper electronic shelf label. The wireless energy burst can last for approximately 1-3 seconds, as an example.

At Block 930, the e-paper electronic shelf label devices power up from the powered-down state to a powered-up state. This is accomplished by control of the switched mode power relay by the ESL device process and control element. Powering up the e-paper electronic shelf label devices includes for each e-paper electronic shelf label device of the e-paper electronic shelf label devices a processor and control element controlling a switched mode power relay to power on the e-paper electronic shelf label device from the powered-down state to the powered-up state when the wireless energy burst is received.

At Block 940, the content displayed by the plurality of e-paper electronic shelf label devices is updated in accordance with the instructions and data of the received wireless energy burst.

In an exemplary embodiment, a power burst is sent to an e-paper ESL. After a short time, the e-paper ESL powers up. Optionally there can be a period during which wait for an acknowledge from the e-paper ESL. The data is then transmitted and the display is updated in accordance with the data, and, if applicable, instructions sent with the data. There can be an optional acknowledge transmitted. Power to the e-paper ESL is cut by stopping power transmission to the e-paper ESL.

As noted, ESL devices have displays that usable in a variety of settings, such as grocery stores, retail locations, and for a variety of purposes, such as traffic signs, advertising, pricing, time tables, electronic billboards, and general signage. The use of e-paper ESLs without the need for batteries offers many advantages. The display content is preserved even if power is removed for a long time, resulting in an essential zero power display device that only needs be supplied with power when needed. The Bi-stable inks of e-paper technology of e-paper electronic shelf label devices require little power to change the display image content. Content information is stored in memory of e-paper electronic shelf label device. In e-paper electronic shelf label devices, voltage is applied to make the picture displayed. Once power is removed, the particles are frozen in that picture. The e-paper ESLs described herein remain essentially off until powered up remotely for the purpose of changing or updating content displayed by them. Because power is only needed to change content, there is no need for battery.

While battery-less e-paper ESLs are described herein, it is noted that the principles described are applicable to an ESL that has a battery, is rechargeable, or with an ultra-capacitor or other capacitive energy storage element.

Power is therefore only needed to change content displayed by display of e-paper electronic shelf label device. To update ESL content, small wireless power transmitter of an update device, such as a wireless, portable update device like an IR or RF gun, beams a short burst of energy containing the instructions and data. The wireless power transmitter may be integrated into the update device.

The representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. An e-Paper electronic shelf label (ESL) device, comprising:
a processor and control element;
a power antenna receiver coupled to the processor and control element;
a memory element coupled to the processor and control element;
a display element coupled to the processor and control element and comprised of electronic paper with a bi-stable electronic ink, wherein the display continues to display content stored in the memory element of the e-paper electronic shelf label device when no power is supplied to the e-paper electronic shelf label device in a powered-down state; and
a switched mode power relay;
wherein in response to the power antenna receiver receiving a wireless energy burst with a wireless magnetic resonating power coupling characteristic when the e-paper electronic shelf label device is in a powered-down state, the processor and control element controls the switched mode power relay to power on the e-paper electronic shelf label device from the powered-down state to a powered-up state.

2. The device of claim 1, wherein the wireless energy burst further comprises instructions and data for updating content displayed by the display element, and wherein upon the wireless energy burst powering up the e-paper electronic shelf label device to the powered-up state, the processor and control element controls the display element in accordance with the instructions to display content determined by the data of the wireless energy burst.

3. The device of claim 1, wherein the one or more e-paper electronic shelf label devices is battery-less.

4. An e-paper electronic shelf label system, comprising:
an update device operable to transmit a wireless energy burst having a wireless magnetic resonating power coupling characteristic and comprised of instructions and data in response to activation of a power activation element of the update device; and
a plurality of e-paper electronic shelf label devices, with each e-paper electronic shelf label device having a powered-down state in which the e-paper electronic shelf label device continues to display content when no power is supplied to the e-paper electronic shelf label device in the powered-down state;
wherein in response to activation of the power activation element of the update device, the update device transmits the wireless energy burst, the wireless energy burst comprising instructions and data is received by one or more e-paper electronic shelf label devices of the plurality of e-paper electronic shelf label devices, the one or more e-paper electronic shelf label devices power-up to a powered-up state, and the powered-up one or more e-paper electronic shelf label devices update and display content in accordance with the instructions and data of the received wireless energy burst.

5. The system of claim 4, wherein each e-paper electronic shelf label device of the plurality of e-paper electronic shelf label devices further comprises a processor and control element, a power antenna receiver coupled to and controlled by the processor and control element, a display element coupled to and controlled by the processor and control element, a switched mode power relay; and a memory element coupled to and controlled by the processor and control element in which content displayed by the display of the e-paper electronic shelf label device is stored.

6. The system of claim 5, wherein the display is comprised of electronic paper with a bi-stable electronic ink.

7. The system of claim 5, wherein in response to the power antenna receiver receiving the wireless energy burst when the e-paper electronic shelf label device is in a powered-down state, the processor and control element controls the switched mode power relay to power on the e-paper electronic shelf label device from the powered-down state to the powered-up state.

8. The system of claim 4, wherein the one or more e-paper electronic shelf label devices is battery-less.

9. The system of claim 4, wherein the update device comprises a processor and control element, a wireless power transmitter coupled to and controlled by the processor and control element and operable to generate the wireless energy burst containing instructions and data, a user interface coupled to and controlled by the processor and control element and having the power activation element;

10. The system of claim 9, wherein the wireless energy burst beamed by the wireless power transmitter is a magnetic resonating wireless transmission and wherein the wireless power transmitter further comprises a magnetic resonator having a resonating frequency.

11. The system of claim 10, wherein the magnetic resonator comprises an inductor coil element and a capacitance plate element and wherein the shape of the inductor coil element determines the resonating frequency of the wireless power transmitter.

12. The system of claim 9, wherein in response to a user activating the power activation element of the user interface, the processor and control element of the update device controls the wireless power transmitter to transmit the wireless energy burst having the wireless magnetic resonating power coupling characteristic.

13. The system of claim 4, wherein the update device is a portable, wireless update device.

14. The system of claim 4, wherein the wireless energy burst having the wireless magnetic resonating power coupling characteristic is beamed within a mid-range distance of the update device, wherein the mid-range distance is in the range of approximately one centimeter to several meters.

15. The system of claim 4, wherein the system further comprises one or more collection power antenna transceivers of one or more corresponding collection devices located at collection locations within the system

16. The system of claim 15, wherein the wireless energy burst is received by the one or more collection power antenna transceivers which then transmit the received energy burst and data to the one or more e-paper electronic shelf label devices.

17. The system of claim 16, wherein the collection locations are located at a ceiling in an area above the one or more e-paper electronic shelf label devices.

18. The system of claim 16, wherein the wireless energy burst received by the one or more collection power antenna transceivers from the update device power up the one or more collection devices containing the one or more collection power antenna transceivers and the one or more collection power antenna transceivers transmit the received energy burst and data to the power antenna receivers of the one or more e-paper electronic shelf label devices.

19. A method for updating content displayed by a display of an e-paper electronic shelf label device, comprising:
the e-paper electronic shelf label device receiving a wireless energy burst comprising instructions and data when in a powered-down state, wherein the wireless energy burst has a wireless magnetic resonating power coupling characteristic and is comprised of instructions and data;
powering up the e-paper electronic shelf label device from the powered-down state to a powered-up state;
updating content displayed by the e-paper electronic shelf label device in accordance with the instructions and data of the received wireless energy burst.

20. The method of claim 19, wherein a power antenna receiver of the e-paper electronic shelf label device receives the wireless energy burst.

21. The method of claim 19, wherein powering up the e-paper electronic shelf label device from the powered-down state to the powered-up state is performed by a switched mode power relay of the e-paper electronic shelf label device under control of a processor and control element of the e-paper electronic shelf label device.

22. A method for updating content displayed by e-paper electronic shelf label devices, comprising:
in response to activation of a power activation element of an update device, transmitting a wireless energy burst having a wireless magnetic resonating power coupling characteristic and comprised of instructions and data;
a plurality of e-paper electronic shelf label devices receiving the wireless energy burst comprising instructions and data while in a powered-down state, wherein the plurality of e-paper electronic shelf label devices continue to display content when no power is supplied to the e-paper electronic shelf label device in the powered-down state;
the plurality of e-paper electronic shelf label devices powering up from the powered-down state to a powered-up state; and
updating the content displayed by the plurality of e-paper electronic shelf label devices in accordance with the instructions and data of the received wireless energy burst.

23. The method of claim 22, wherein transmitting further comprises a wireless power transmitter of an update device transmitting the wireless energy burst and wherein receiving the wireless energy burst further comprises for each e-paper electronic shelf label device of the plurality of e-paper electronic shelf label devices a power antenna receiver of the e-paper electronic shelf label receiving the wireless energy burst.

24. The method of claim 23, wherein the wireless power transmitter has a magnetic resonator with a resonating frequency and wherein the power antenna receiver of the e-paper electronic shelf label has a resonating frequency proximate that of the magnetic resonator of the wireless power transmitter.

25. The method of claim 22, wherein powering up the plurality of e-paper electronic shelf label devices comprises for each e-paper electronic shelf label device of the plurality of e-paper electronic shelf label devices a processor and control element controlling a switched mode power relay to power on the e-paper electronic shelf label device from the powered-down state to the powered-up state when the wireless energy burst is received.
